(19) United States
(12) Patent Application Publication
(10) Pub. No.: US 2006/0019542 A1
(43) Pub. Date: Jan. 26, 2006

(54) Single-port to multi-port cable assembly

(76) Inventor: Jerry Wu, Irvine, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/898,070

(22) Filed: Jul. 23, 2004

(51) Int. Cl. H01R 25/00

(52) U.S. Cl. 439/638

(57) ABSTRACT

A cable assembly (100) includes a first connector (1), a number of second connectors (2) each having a serial advanced technology attachment interface, and cable means (3) connecting the first and the second connectors. The first connector includes a unitary first longitudinal insulative housing (10) having an upper and a lower elongated side walls (1040, 1041) opposite to each other in a lateral direction and respectively defining a plurality of first and second passageways therein, a number of signal contacts disposed in corresponding first passageways, and a number of power contacts disposed in corresponding second passageways. The cable means includes a plurality of sets of wires, each set electrically connecting with the first connector and a corresponding second connector.

### BACKGROUND OF THE INVENTION

1. Field of the Invention

The present invention relates generally to a cable assembly, and more particularly to a high speed Serial Advanced Technology Attachment (SATA) cable assembly.

2. Description of the Prior Art

Parallel ATA (Advanced Technology Attachment) and parallel SCSI (Small computer System Interface) are two dominant disk interface technologies in past long period. The parallel ATA disks are widely used in desktop PCs and mobile PCs, and the parallel SCSI disks are mainly used in high-volume servers and subsystems. As disk interconnect speeds continue to rise, existing parallel ATA and parallel SCSI buses are reaching their performance limits because that parallel transmissions are susceptible to crosstalk across multiple streams of wide ribbon cable that adds line noise and can cause signal errors—a pitfall that has been remedied by slowing the signal, limiting cable length or both. In view of the requirements for a high-speed transmission, an organization, named Serial ATA (SATA) Working Group proposes a specification defining a SATA interface. SATA interface is developed with a fast signal transmission speed of up to 1.5 Gbps between storage devices (such as hard disks, floppy drives, CD-ROMs, and DVDs) and a motherboard. Numerous advantages of SATA make it gradually replace Parallel ATA and Parallel SCSI interfaces and become the next generation personal computer storage interface. Correspondingly, SATA connectors and SATA cable assemblies have been designed and developed by many companies in the art.

A conventional SATA cable connector assembly is disclosed in art for connecting a first electrical device, such as a motherboard in a personal computer or a server with a second electrical device, such as a hard disk of the personal computer or the server. The cable connector assembly comprises cable means having opposite two ends, and a first and a second connectors each connected to one end of the cable means. The first and the second connectors both receive a plurality of power and signal contacts. The cable means comprises power cables for transmitting power between the first and the second connectors and signal cables for transmitting signal between the first and the second connectors. Therefore, one such one-to-one cable assembly is only for connecting the motherboard with one hard disk. As widely known, a storage device of the personal computer or the server has only a limited storage capability, which is hard to meet users' higher and higher requirements. In this case, a motherboard having at least two SATA interfaces which can simultaneously connect with at least two hard disks gradually springs up in nowaday market. Correspondingly, at least two SATA cable assemblies with mentioned structure are simultaneously used to transmit signal and power between a motherboard and at least two hard disks. However, using large numbers of cable assemblies must increase complexity and occupy larger space in the electrical device.

Another conventional SATA cable assembly entitled “SATA INTERFACE RELAY CONNECTOR AND ITS APPLICATION” is disclosed in U.S. Pat. No. 6,719,591. The cable assembly comprises a repeator connector 11 having a signal section 11a and a power supply section 12a, a signal connector 11c, a power input connector 12b, a signal cable 11b for connecting the signal section 11a with the signal connector 11c, and a power cable 12d for connecting the power supply section 12a and the power input connector 12b. The cable assembly is used for transmitting signals between a computer and a peripheral device, such as a 5.25-inch CD ROM, DVD ROM, CD-R, and CD-RW drives as well as mobile racks. However, the similar problem is existed. When the computer wants to communicate with a plurality of peripheral devices, a number of cable connector assemblies have to be used.

Hence, in this art, a new type SATA cable assembly to overcome the above-mentioned disadvantages of the prior art will be described in detail in the following embodiments.

### BRIEF SUMMARY OF THE INVENTION

A primary object, therefore, of the present invention is to provide a high-speed cable assembly for transmitting signals between a first electrical device and at least two second electrical devices.

Another object, therefore, of the present invention is to provide an electrical connector with a plurality of power and signal contacts respectively arranged in different side walls of a housing for connecting with at least two SATA connectors.

In order to implement the above object and overcomes the above-identified deficiencies in the prior art, the high speed cable assembly in accordance with the present invention comprises a first connector, a plurality of second connectors each having a serial advanced technology attachment interface, and cable means connecting the first connector and the second connectors. The first connector comprises a first longitudinal insulative housing having an upper and a lower elongated side walls opposite to each other in a vertical direction and respectively defining a plurality of first and second passageways therein, a plurality of first contacts disposed in corresponding first passageways, and a plurality of second contacts disposed in corresponding second passageways. The cable means comprises a plurality of sets of wires, each set electrically connecting with the first connector and a corresponding second connector.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a cable assembly in accordance with the present invention in conjunction with a corresponding edge card.

FIG. 2 is an exploded view of a first connector of the cable assembly.

FIG. 3 is an exploded view of the first connector of the cable assembly in another point of view different from FIG. 2.

FIG. 4 is a front view of the first connector of the cable assembly.

FIG. 5 is a cross-sectional view of the first connector of the cable assembly taken along line 5-5 of FIG. 4.

FIG. 6 is a cross-sectional view of the first connector of the cable assembly taken along line 6-6 of FIG. 4.

FIG. 7 is a cross-sectional view of the first connector of the cable assembly taken along line 7-7 of FIG. 4.

FIG. 8 is a perspective view of a second connector of the cable assembly.

### DETAILED DESCRIPTION OF THE INVENTION

Reference will now be made in detail to preferred embodiments of the present invention.

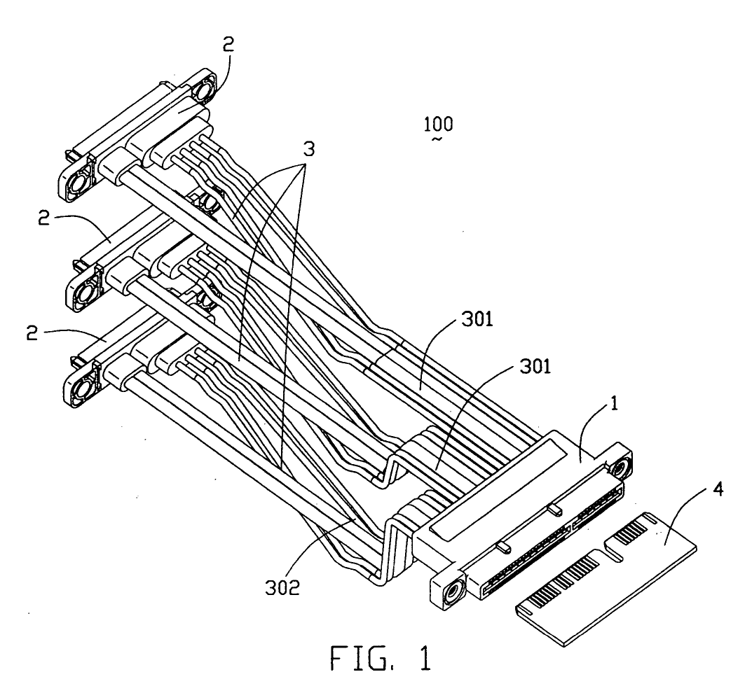

Referring to FIG. 1, a cable assembly 100 in accordance with a first preferred embodiment of the present invention comprises a first connector 1 for mating with an edge card 4, a plurality of second connectors 2 each for connecting to a complementary connector (not shown), and cable means 3 connecting the first and the second connectors 1 and 2 and comprising a plurality of sets, each terminated to one second connector 2.

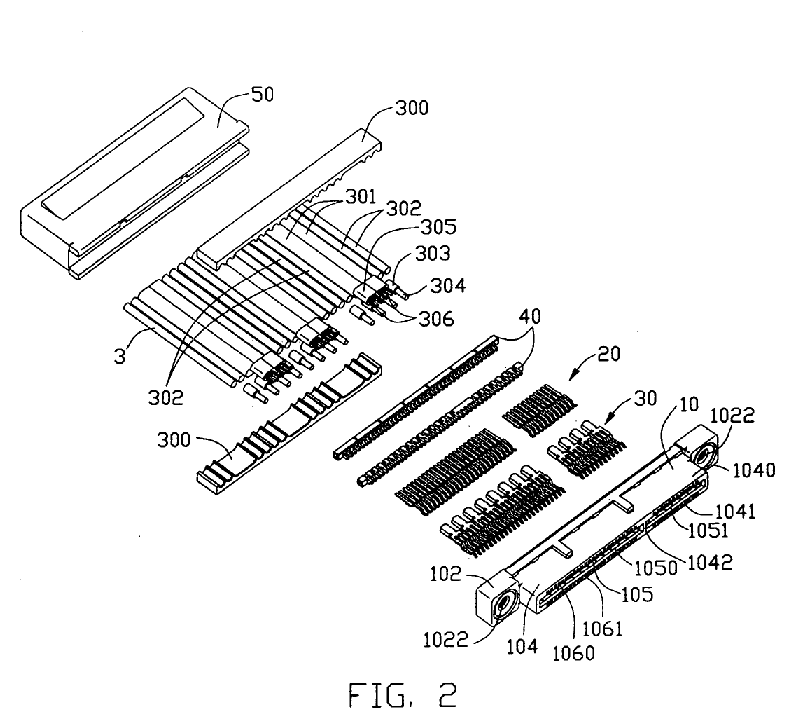

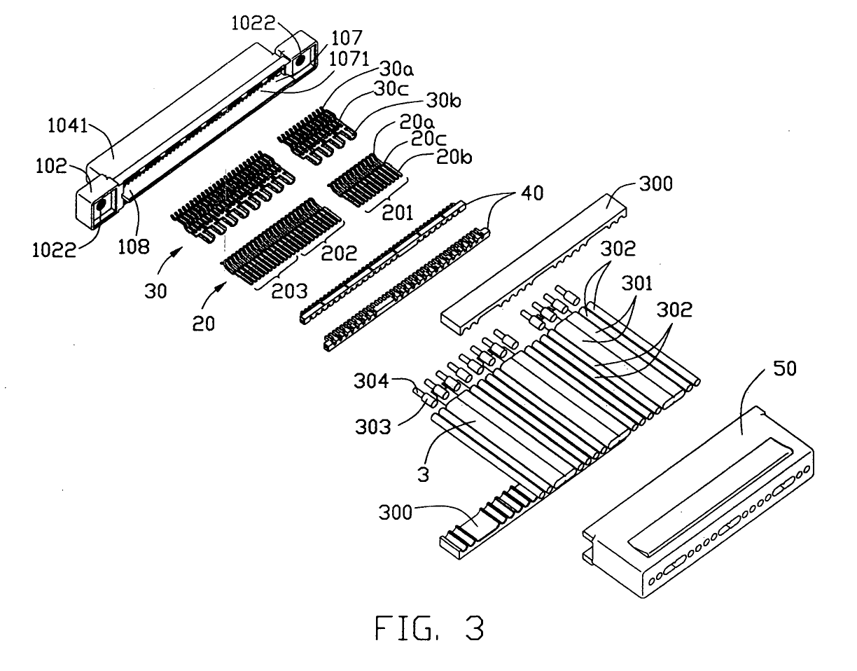

Referring to FIGS. 2-3, an exploded first connector 1, in conjunction with the cable means 3 is shown in different aspect of views. The first connector 1 comprises an first insulative housing 10, a plurality of first and second contacts 20, 30 retained in the first insulative housing 10, two spacers 40 and a cover 50.

The first housing 10 has an elongated base 102 and a mating section 104 extending perpendicularly and outwardly forming a front face of the base 102. The mating section 104 comprises parallel first and second side walls 1040, 1041 corresponding to each other in a vertical direction and defines a mating port 105 between the first and the second side walls 1040, 1041. The mating port 105 is obscured into side-by-side first and second mating ports 1050, 1051 by a baffle 1042, wherein the first mating port 1050 has a lengthwise dimension smaller than the second mating port 1051. The base 102 defines a longitudinal central cavity 107 communicating with the mating port 105. The base 102 further defines a pair of mounting holes 1022 adjacent opposite ends thereof.

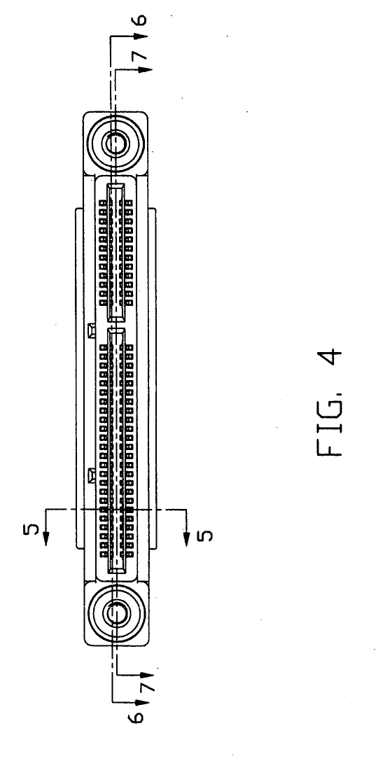

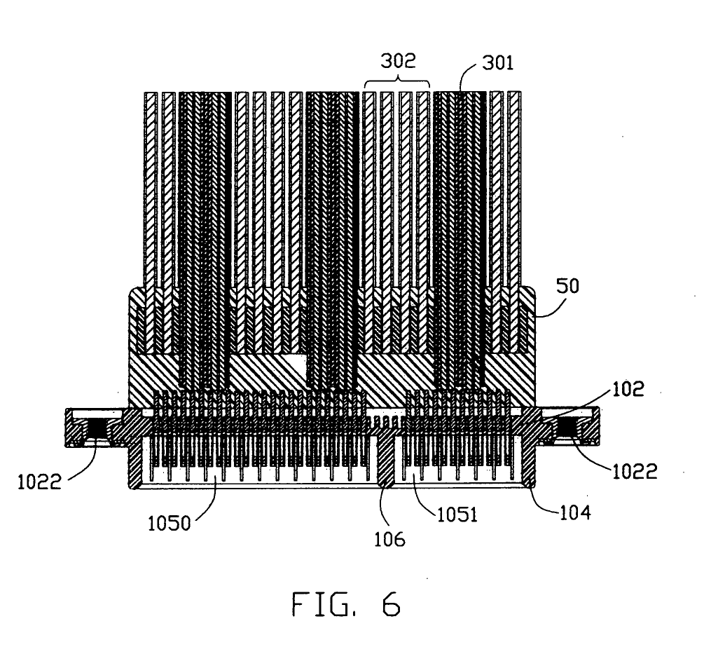

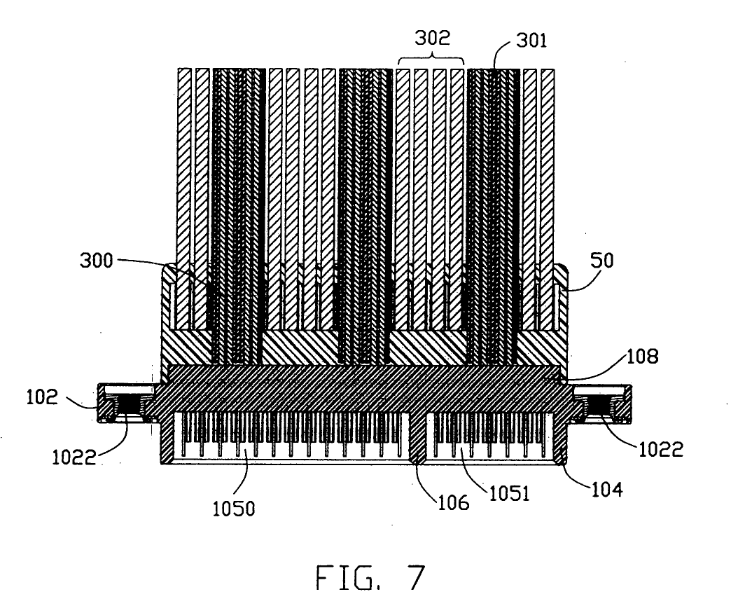

In conjunction with FIGS. 4-7, the housing 10 is integrally formed with a clapboard 108 extending rearwardly therefrom. The clapboard 108 is parallel to the first and second side walls 1040, 1041 and divides the central cavity 107 into an upper and a lower cavities 1070, 1071. The housing 10 defines a plurality of first passageways 1060 in the first side wall 1040 communicating with the upper cavity 1070, and a plurality of second passageways 1061 in the second side wall 1041 communicating with the lower cavity 1071.

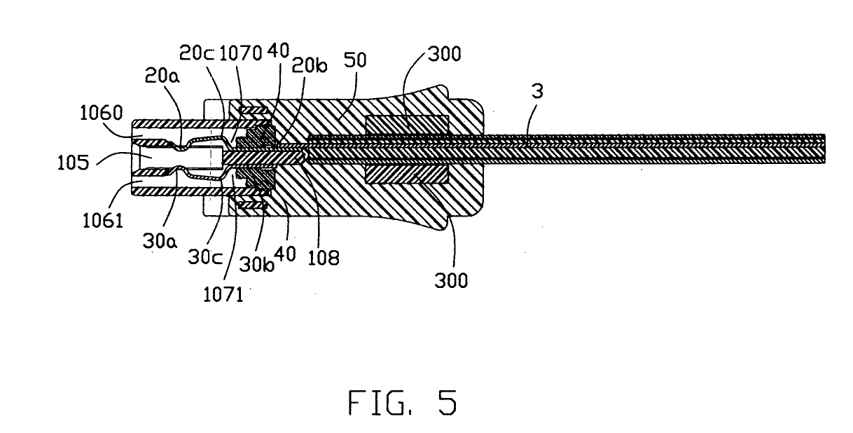

Referring to FIGS. 3 and 5, the first and the second contacts 20, 30 are assembled into the first and the second passageways 1060, 1061, respectively. The first contacts 20 are signal contacts each comprise a contact portion 20a having signal contact section curved into the mating port 105, a tail portion 20b rearwardly extending into the upper cavity 1070 and out of the base 102 for connecting to the cable means 3, and an retention portion 20c interconnecting the contact portion 20a with the tail portion 20b. The second contacts 30 are power contacts each comprise a contact member 30a having power contact sections curved into the mating port 105. Three contacts members commonly have a tail member 30b rearwardly extending into the lower cavity 1071 and out of the base 102 for connecting to the cable means 3. A retention member 30c interconnects each contact member 30a and corresponding tail member 30b.

The spacers 40 have the same configuration and are both made of plastic material. Two spacers 40 are respectively mounted in upper cavity 1070 and lower cavity 1071 from a rear face (not labeled) of the first housing 10 to seal the rear face except for the plurality of passageways through which the tail portions 20b of the contacts 20, 30 extend rearwardly.

The cover 50 is over-molded on the base 102 of the first housing 10 with the cable means 3 and the first housing 10. Thus, the electrical cable assembly 100 is formed as best shown in FIG. 1.

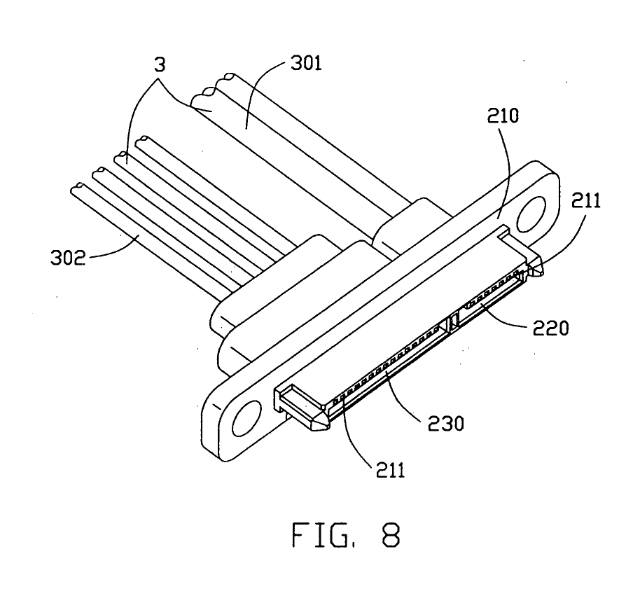

Referring to FIG. 8, the second connectors 2 comprise three connectors having the same structure, each comprising an second insulative housing 210 defining therein a plurality of channels 211 and two L-shaped SATA interfaces arranged in a back-to-back manner in the lengthwise direction, wherein a shorter one is a signal interface 220 and a longer one is a power interface 230. A plurality of signal and power terminals (not shown) are received in the corresponding channels 211 respectively.

Referring again to FIGS. 1-8, the cable means 3 is fixed by two clamps 300 in the cover 50 and comprises a plurality of wires divided into a first set, a second set, and a third set, respectively connected to one of the second connectors 2. Each set of wires comprises a pair of signal wires 301 arranged in side-by-side manner for connecting corresponding signal contacts 20 of the first connector 1 and signal terminals of the second connector 2, and four power wires 302 for connecting the power contacts 30 of the first connector 1 and the power terminals of the second connector 2. Each power wire has a jacket 303 at one end thereof and a conductor 304 extending therefrom for soldering with a corresponding power contact 30. Each signal wire has a wrap 305 at one end thereof and four conductors 306 extending therefrom for soldering with corresponding signal contacts 20.

As easily conceived, the cable assembly 100 in accordance with another embodiment of the present invention comprises two or more than three second connectors 2 having the same structure, each for connecting to a complementary connector. Accordingly, the configuration of the first connector 1, the amount of the contacts 20, 30 and the wires 301, 302 are needed to be alerted to some extent for concerting with the second connectors.

In a third embodiment of the present invention, the plurality of second connectors 2 may have different configurations, while the first connector 1 has a similar configuration as described in the first embodiment. Some of the second connectors 2 are only connected to power wires or only connected to signal wires.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A cable assembly, comprising:
a first connector comprising;
a unitary first insulative housing having an elongated side wall defining a plurality of passageways therein; and
a plurality of first and second contacts disposed in corresponding passageways;
at least two second connectors, each comprising a second insulative housing and a plurality of third contacts disposed in the second housing; and
cable means comprising a plurality of wires electrically connecting with the first and the second connectors, the wires being formed of a plurality of sets, each set terminated to corresponding second connector.

2. The cable assembly as claimed in claim 1, wherein the second connectors are serial advanced technology attachment connectors.

3. The cable assembly as claimed in claim 1, wherein the first connector and the second connectors form one-to-three relationship.

4. The cable assembly as claimed in claim 1, wherein the side wall comprises parallel first and second side walls opposite to each other in a vertical direction and having the same length, each side wall defining therein the plurality of passageways.

5. The cable assembly as claimed in claim 4, wherein the first housing defines a mating port thereof along the lengthwise direction and a central cavity communicating with the mating port.

6. The cable assembly as claimed in claim 5, wherein the central cavity is interrupted by a clapboard parallel to the first and the second side walls for blocking off the first and the second contacts.

7. The cable assembly as claimed in claim 1, wherein the first and the second contacts each comprise a contact portion with a contact section curved into the mating port of the housing, a tail portion extending outwardly from the housing for connecting with a corresponding wire, and a retention portion connecting the contact portion and the tail portion.

8. The cable assembly as claimed in claim 7, wherein the retention portion of the first contact connects with one tail portion and one contact portion, while the retention portion of the second contact connects with one tail portion and a plurality of contact portions.

9. The cable assembly as claimed in claim 1, wherein at least one of the second connectors has both power and signal contacts aligned side-by-side in a row.

10. The cable assembly as claimed in claim 9, wherein each sets of wires comprises both signal wires and power wires.

11. An electrical connector, comprising:
an insulative housing defining a mating port extending along a lengthwise direction, with first and second side walls corresponding to each other in a vertical direction by two sides thereof, the first side wall defining a plurality of first passageways therein, the second side wall defining a plurality of second passageways therein,
a plurality of signal contacts disposed in corresponding first passageways, respectively; and
a plurality of power contacts disposed in corresponding second passageways, respectively, wherein
the amount of the signal contacts is equal to that of the power contacts.

12. (canceled)

13. The electrical connector as claimed in claim 11, wherein each first passageway is corresponding to a second passageway in the vertical direction.

14. The electrical connector as claimed in claim 13, wherein the first and the second side walls have the same length and the same width.

15. The electrical connector as claimed in claim 11, wherein the mating port comprises a first and a second mating ports being separated by a baffle disposed between the first and the second side walls in the vertical direction, the first mating port having a smaller length than the second mating port.

16. The electrical connector as claimed in claim 11, wherein the housing further comprises a base defining a central cavity therein communicating to the mating port, the central cavity being obscured by a clapboard for blocking off the signal contacts and the power contacts.

17. The electrical connector as claimed in claim 16, wherein the signal and the power contacts each comprise a contact portion with a contact section curved into the mating port of the housing, a tail portion received in the cavity and extending outwardly form the housing for connecting with a corresponding wire, and a retention portion received in corresponding passageway and connecting the contact portion and the tail portion.

18. The electrical connector as claimed in claim 16, wherein two spacers are respectively arranged between the clapboard and the first and the second side walls for engaging with the signal and the power contacts.

19. A cable assembly, comprising:
at least two first cables used for transmitting signal;
at least two second cables used for transmitting power;
a first connector electrically connected with the first cables and the second cables;
a second connector electrically connected with the first cable and the second cable; and
a third connector electrically connected with the second cable.

20. The cable assembly as claimed in claim 19, wherein the third connector is further electrically connected with the first cable.

21. The cable assembly as claimed in claim 20, wherein the second and the third connectors have the same structure.

22. The cable assembly as claimed in claim 20, wherein the second and the third connectors have different structures.

23. The cable assembly as claimed in claim 20, wherein the second and the third connectors are both serial advanced technology attachment connectors.

24. A cable assembly comprising:
a first set cable including a first set of power wires and a first set of signal wires side by side arranged together;
a second set cable including a second set of power wires and a second set of signal wires side by side arranged together,
a common connector having a large transverse dimension thereof and connected to both first end of the first set cable and first end of the second set cable;
a first connector having a small transverse dimension thereof and connected to a second end of the fist set cable; and
a second connector having a small transverse dimension thereof and connected to a second end of the second set cable.

25. The assembly as claimed in claim 24, wherein said first connector and said second connector are arranged in a stacked manner.

26. The assembly as claimed in claim 24, wherein the first set of power wires and the first set of signal wires are respectively arranged to be separated from each other in the first connector along a transverse direction while are intermingled with each other in said common connector along the transverse direction.
